(19) United States
(12) Patent Application Publication
(10) Pub. No.: US 2008/0083862 A1
(43) Pub. Date: Apr. 10, 2008

(54) Hanger assembly

(76) Inventor: Robert G. Salatka, Encinitas, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/546,491

(22) Filed: Oct. 10, 2006

(51) Int. Cl. F16B 45/00

(52) U.S. Cl. 248/308

(57) ABSTRACT

A hanger assembly for being placed on a flat horizontal surface for hanging objects downwardly comprises a support structure and an axial shaft mounted in the support structure, and an elongated hanger rod extending perpendicular from the shaft along acute angles within an arc of ±30° relative to the horizontal surface. In one embodiment, the axial shaft is stationary and the hanger rod is hinged on the axial shaft. In another embodiment, the axial shaft is rotatably mounted on the support structure and the hanger rod is stationary on the axial shaft or is rotatably mounted on the shaft.

### BACKGROUND OF THE INVENTION

It is usually inconvenient or difficult to find a suitable location for placing a handbag, purse or the like on a table in a restaurant, lounge, nightclub, etc. It is undesirable to place an attractive or valuable handbag on the floor of such an establishment.

### SUMMARY OF THE INVENTION

The hanger assembly described herein is adapted for being placed on a generally flat horizontal elevated surface, such as a tabletop, countertop, shelf or similar flat surface for conveniently hanging objects downwardly from the tabletop, etc. The hanger assembly is small enough to be conveniently carried on a handbag strap or in the handbag until it is to be used.

The hanger assembly described herein comprises a support structure for resting on a generally flat elevated surface and having a transverse axial shaft extending along a single first axis and a hanger rod having a proximal end pivotally or rotatably secured relative to the axial shaft. The proximal end of the hanger rod is perpendicular to the axial shaft and extends from the shaft along axes extending at acute angles of between about ±30°, preferably about ±20° and more preferably about ±15° relative to the horizontal plane of the flat surface on which the hanger assembly rests and from which a handbag or the like is suspended. In one preferred embodiment, the axial shaft is stationary and rigidly secured in the support structure, and the proximal end of the hanger rod is coaxially mounted on the axial shaft to provide rotational, hinged movement of the hanger rod within an arc of the aforesaid angles. In a modified version of the embodiment, a pair of stationary coaxial shafts are used. In another preferred embodiment, the axial shaft is rotatably mounted within the support structure and the proximal hanger rod end is rigidly secured to and extends from the axial shaft for pivotal movement within an arc of the aforesaid angles. In yet another preferred embodiment, the axial shaft is rotatably mounted in the support structure for rotation along a first axis and the proximal end of the hanger rod is rotatably secured to, in, or through the axial shaft for rotation along a second axis, normal to the first axis and extends from the axial shaft and is moveable within an arc of the aforesaid acute angles relative to a horizontal plane on which the hanger assembly rests. In another preferred embodiment, the hanger rod is hinged to provide an enclosed loop for securing the hanger assembly on the strap of a handbag. The detailed description of different embodiments of the hanger assembly, components and advantages will be further described hereinafter.

### BRIEF DESCRIPTION OF THE DRAWINGS

FIG. 1A is a perspective view of a preferred embodiment of a hanger assembly including a hinged hanger rod in an open position; FIG. 1B is an exploded view of the hanger assembly of FIG. 1A;

FIG. 2 is an exploded perspective view of a hanger assembly having a pair of coaxial shafts for securing the hanger rod;

FIG. 3 is a perspective view of the hanger assembly of FIG. 1A with the hinged hanger rod folded to a closed condition:

FIG. 4 is a front view of another embodiment of the hanger assembly;

FIG. 5 is a side sectional elevation of the embodiment shown in FIG. 4 taken along line A-A;

FIG. 6 is a perspective view of another hanger assembly embodiment; and

FIG. 7 is a side view of the embodiment of FIG. 1A shown resting on a table or countertop and supporting a handbag on the hanger rod.

### DETAILED DESCRIPTION OF THE PREFERRED EMBODIMENTS

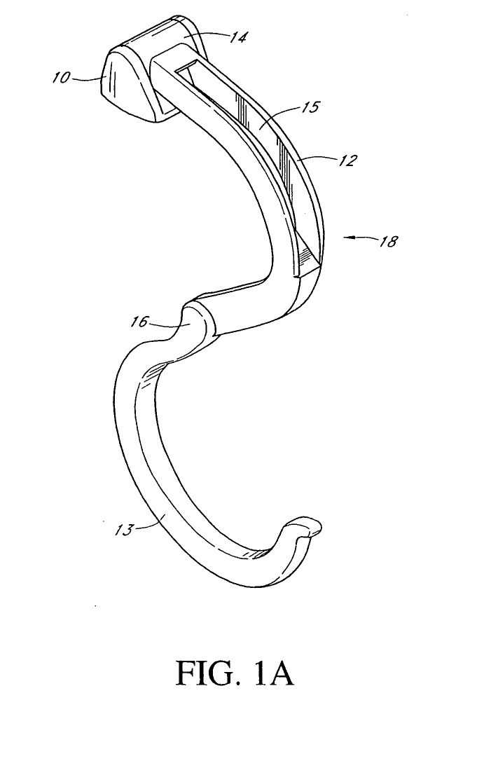

In a first preferred embodiment shown in FIGS. 1-3, a hanger assembly is illustrated and configured for being removably placed on a generally flat horizontally elevated surface, such as a table, shelf or the like, for suspending objects such as a handbag downwardly from the horizontal surface. In this embodiment, a single or fixed or stationary pair of axial shafts are used, and the hanger rod is coaxially mounted on the shaft or shafts for rotational, hinged movement. In FIGS. 1A and 1B, the embodiment illustrated comprises a support structure 10 having a stationary axial shaft 11. The support structure including the axial shaft is preferably molded as a single unit with the axial shaft permanently mounted transversely between the sides of the support structure. A collar 14 is secured to the proximal end of the hanger rod 18. The exterior surface of the axial shaft is cylindrical and cooperates with arched cylindrical interior surface of coaxially mounted collar 14 to provide hinged rotation of the collar relative to the axis of the axial shaft. The proximal end segment 12 of the hanger rod with collar 14 can be molded as a single component, or the collar may be attached by other suitable means, such as adhesive, ultrasonic welding, soldering, or otherwise as known to those skilled in the art. The collar is preferably provided with a slot along its length so that it can be snap-fit over the axial shaft 11 during assembly and disassembly, and conveniently removed for storage or for replacement of the hanger rod, etc. The bottom surface of the support structure 10 is preferably provided with a non-slip material pad 19 or coating such as latex, rubbery silicone, and the like known to those skilled in the art.

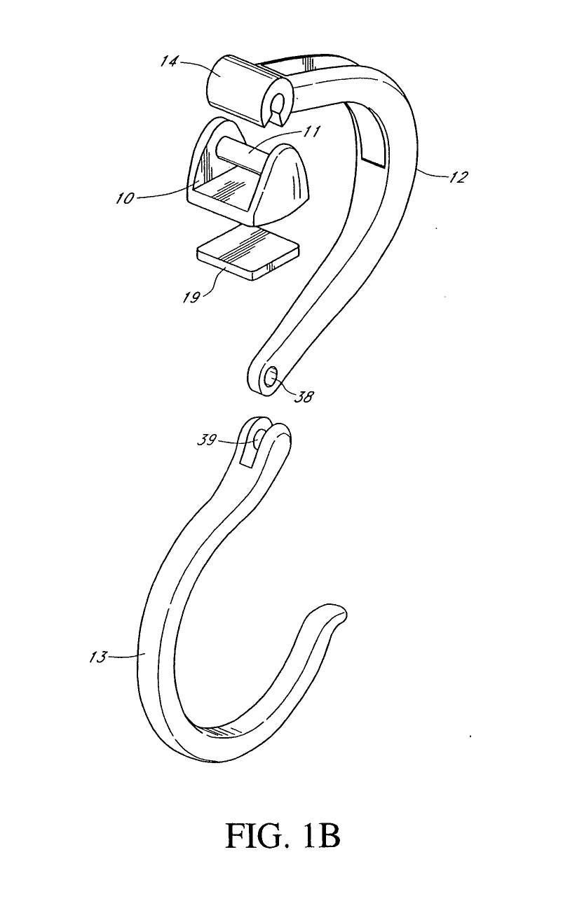

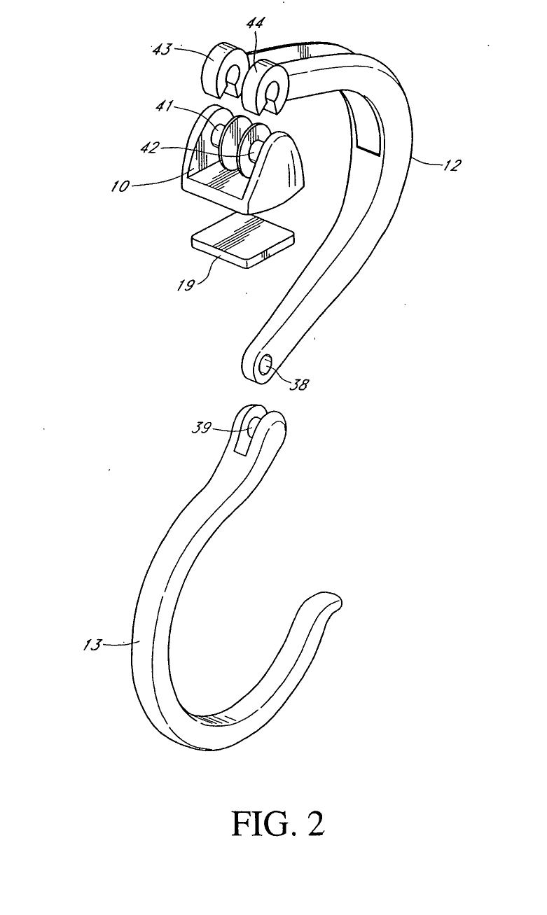

The hanger rod 18 comprises a proximal hanger rod portion 12 and a distal portion 13, both of which are arched or curved in opposite directions forming an S-like shape. A hinge 16 is illustrated, and allows for hinged movement of the proximal and distal hanger rod portions so that they can be folded as well as opened in the same plane as illustrated in FIGS. 1 and 3. Preferably, the proximal and distal hanger rod portions are of a length, and their arches are of a dimension and shape, whereby a closed condition as illustrated in FIG. 3 provides a space 17 for securing the assembly on a handbag strap, with the strap extending through the space. Any suitable hinge arrangement and structure may be used. Where the components are molded from plastic, a snap-fit type of hinge with nipples, studs or other protuberances 39 molded on the end of a hanger rod segment and a notch or opening 38 for receiving the protuberances such as shown in FIGS. 1B and 2 may be used. Although the proximal and distal hanger rod portions shown are about equal in length, any suitable lengths can be used to achieve the aforesaid feature.

In the embodiment shown in FIG. 2, the support structure uses a divided axial shaft comprising a pair of coaxial shafts 41 and 42, and preferably slotted collars 43 and 44 are secured on the proximal end of the hanger rod for rotating (hinged) mounting on the coaxial shafts, respectively. The slotted collars are conveniently snap-fit on the shafts during assembly. Alternatively, a single-shaft may be used with the divided collar design.

The hanger rod embodiments shown in FIGS. 1-3 incorporate a bifurcated proximal end segment forming a slot 15 for receiving the distal end segment of the hanger rod in a folded condition. However, other configurations and designs may be used, preferably providing means for releasably securing the distal and proximal hanger rod segments in a folded condition. Alternatively, the support structure may be provided with means for securing or receiving the distal hanger rod segment. For example, a notch may be formed on the support structure to receive the distal hanger rod portion in a folded condition.

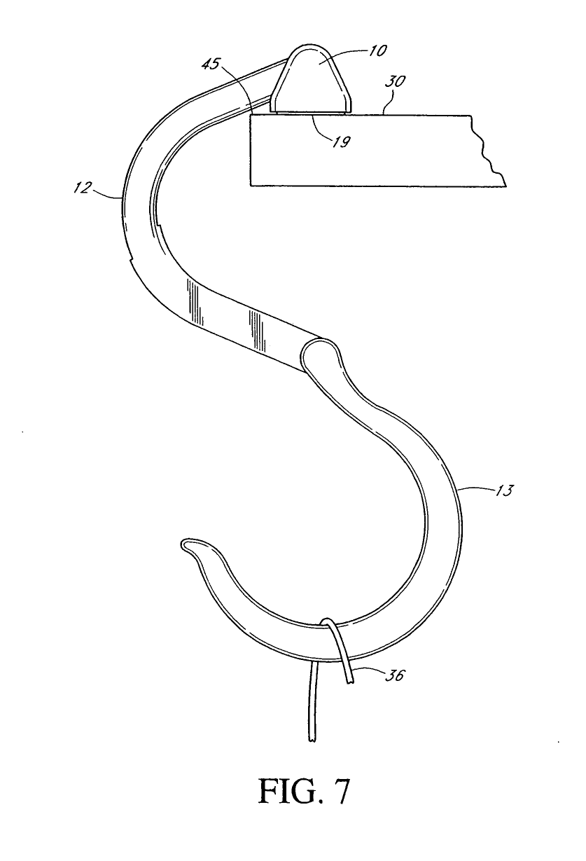

As also illustrated in FIGS. 1-3, the proximal end 12 of the hanger rod extends at an axis perpendicular or normal to the axis of axial shaft 10. Moreover, the coaxial rotation of the collar mounted on the stationary axial shaft or shafts secured in the support structure is limited as is the rotational or hinged movement of the proximal end of the hanger rod. Preferably, the pivotal or hinged movement of the hanger rod on the axial shaft is limited to an arc of acute angles of between about ±30°, preferably about ±20° and more preferably about ±15° relative to a horizontal surface 30 on which the assembly is placed. Thus, the movement of the proximal end of the hanger rod is within an arc of 60°, preferably about 40° and more preferably about 30°. Such a limited movement effectively allows the pivoted hanger rod to gravitationally position itself to support a handbag secured on the hook or curve of the distal portion of the hanger rod. If unimpeded, the handbag settles or comes to rest gravitationally generally along a vertical axis extending between the handbag and the center of the axial shaft. Observing FIG. 7, the proximal end 12 of the hanger rod is at an acute angle of about 15° downwardly from the horizontal plane of surface 30, without interfering with countertop edge 45. The rotational or hinged movement of the hanger rod as described may be limited by any suitable feature of the assembly. For example, in the embodiments illustrated in FIGS. 1-3, the front edge of the support structure acts as a limit or stop for further downward movement of the proximal hanger rod segment. The edges of the slots or flanges formed on the collar may also act to limit the arc of rotation of the collar on the axial shaft. Other equivalent components may be used as well.

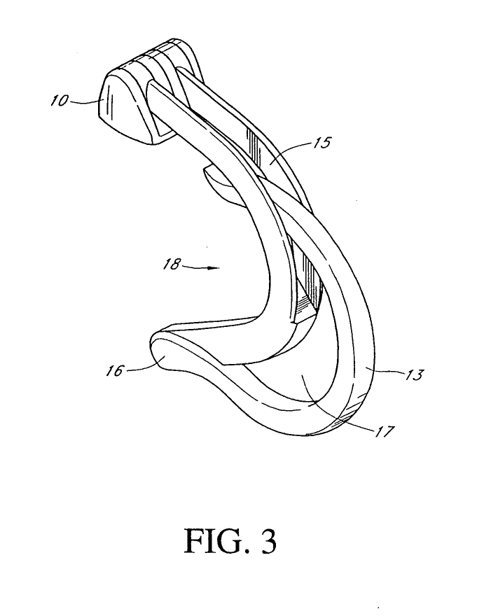

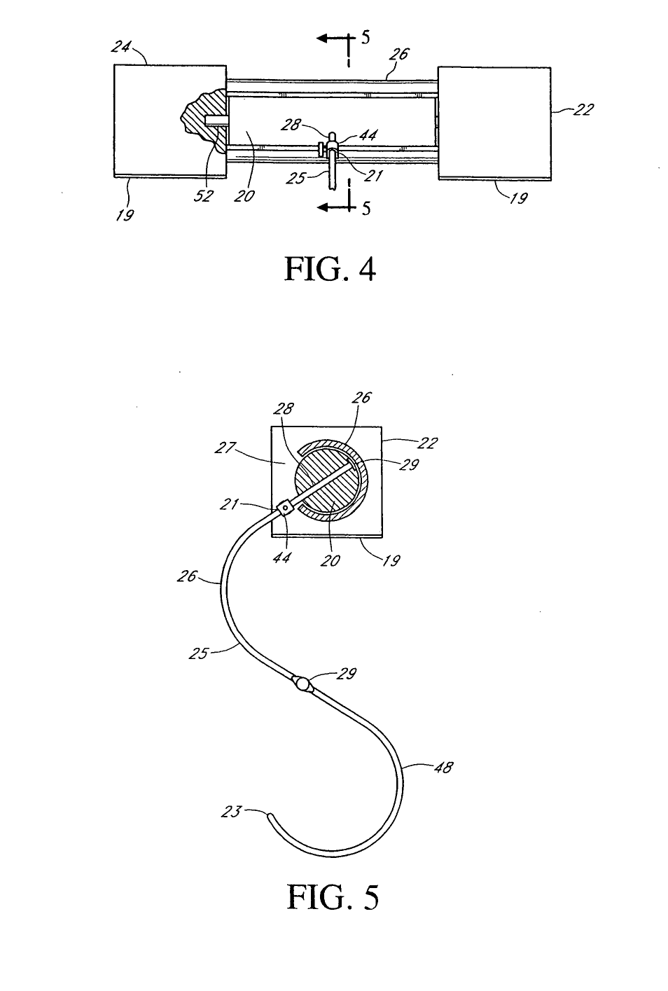

FIGS. 4 and 5 illustrate components of another preferred embodiment of a hanger assembly configured for being removably placed on a generally flat horizontal elevated surface for hanging objects such as a handbag downwardly from the horizontal surface. In this embodiment, the axial shaft is rotatably mounted in the support structure. Moreover, the proximal end of the hanger rod is also rotatably secured to or mounted on the axial shaft. Referring to FIG. 4, support members 22 and 24 are positioned on opposite sides of the assembly and are rigidly secured by a lateral connector 26. The specific shape and dimensions of the support member and lateral connector(s) may be designed to any suitable configuration so long as the assembly is properly supported as described herein. For example, the support members 22 and 24 may be in the form of posts, columns and the like, the size and shape of which will depend on the size and appearance of the assembly desired. Similarly, one or more lateral connectors 26 may be used, in the form of rods, panels, and the like which may be secured to form a substantially rigid support structure for the rotatable shaft or cylinder 20. In the embodiment illustrated, the lateral connector 26 is in the form of an arch or semi-cylindrical component which is glued, welded or otherwise secured to both support members 22 and 24. The ends of the lateral connectors may be adhered directly to the inner sides of the support members, or the support members may be notched or recessed for receiving ends of the one or more lateral connectors. For example, such securing may be in the form of depressions or slots in which ends of the one or more connectors may be snap-fit and secured, and/or they may be glued or otherwise secured, e.g., ultrasonically bonded or by using other means known in the art.

A rotatable axial shaft or cylinder is secured transversely in the support structure between the support members and is rotatably secured to the support members by axle 52 shown in the cut-away of support member 24. An axle at the opposite end of the rotatable cylinder 20 will be similarly secured in support member 22. The construction of the axle or other components for rotatably securing the axial shaft or cylinder 20 may include bearings, bushings, sleeves, spindles, hinges or other components known in the art for securing the shaft or cylinder and permitting axial rotation of the shaft along its axis between the support members 22 and 24. The axis of rotation of the shaft or cylinder 20 will be spaced above the horizontal surface on which the hanger assembly is to be placed during use and will also be substantially horizontal and parallel to the horizontal table surface on which the assembly rests. As shown in FIG. 5, lateral connector 26 is provided with an opening 27 sufficient to allow the cylinder 20 to rotate so that the proximal hanger rod segment can rotate with the cylinder within an arc of about ±30°, preferably about ±20° and more preferably about ±15° relative to the plane of a horizontal surface on which the assembly is used. The edges of opening 27 act as a stop to limit hanger rod rotation within an arc of the aforementioned angles.

Referring again to FIG. 5, a second shaft 28 is rotatably secured in and/or through the rotatable axial shaft or cylinder 20. The second shaft is rotatable on an axis perpendicular or normal to the axis of rotation of the axial shaft. Such a feature may be accomplished by forming or drilling a hole through cylinder 20 slightly larger than the diameter of the second shaft 28 to provide for the perpendicular rotation. The second shaft may be rotatably secured in the first shaft by any suitable means, such as journal bearings, keys, sleeves, and button head 29 as illustrated in FIG. 5. However, it is to be understood that the second shaft may be rotatably secured in the first shaft by other means or components known to those skilled in the art. It will also be observed that the diameter of the axial shaft is greater than the diameter of the second shaft so as to provide sufficient housing for rotatable movement of the second shaft in and/or through the axial shaft or cylinder.

Hanger rod 25 is shaped for securing straps or other components of a handbag, purse or other object to be supported by the assembly downwardly from an elevated tabletop or other horizontal surface. The hanger rod includes a proximal end 21 secured to the second rotatable shaft 28 and an opposite distal end 23. Any suitable means for attaching the proximal end 21 of the hanger rod 25 to the second rotatable shaft 28 may be used. As illustrated, a collar 44 secured to the end of rotatable shaft 28 and provided with an interior channel for inserting the proximal end of the hanger rod is used for connecting the hanger rod to the rotatable shaft 28. A thumb screw threaded into the side of the collar may be provided for tightening and securing the proximal end of the hanger rod in the collar 44. Any other means for attaching and/or securing the proximal end of the hanger rod to the rotatable shaft 28 may be used. Alternatively, the assembly may be designed whereby the hanger rod itself is an extension of the rotatable shaft 28 with the hanger rod permanently secured to and forming an extension or component of the second rotatable shaft.

Also referring to FIG. 5, the hanger rod is preferably hinged, with a hinge 29 illustrated along the length of the hanger rod. The hanger rod illustrated comprises a proximal hanger rod portion 26 and a distal portion 48. The hinge allows the hanger rod to be folded when it is not in use and provides a smaller profile for storage in a handbag. Moreover, the hinged hanger rod design also creates a space for securing a handbag and hanging the assembly from a handbag strap as previously described.

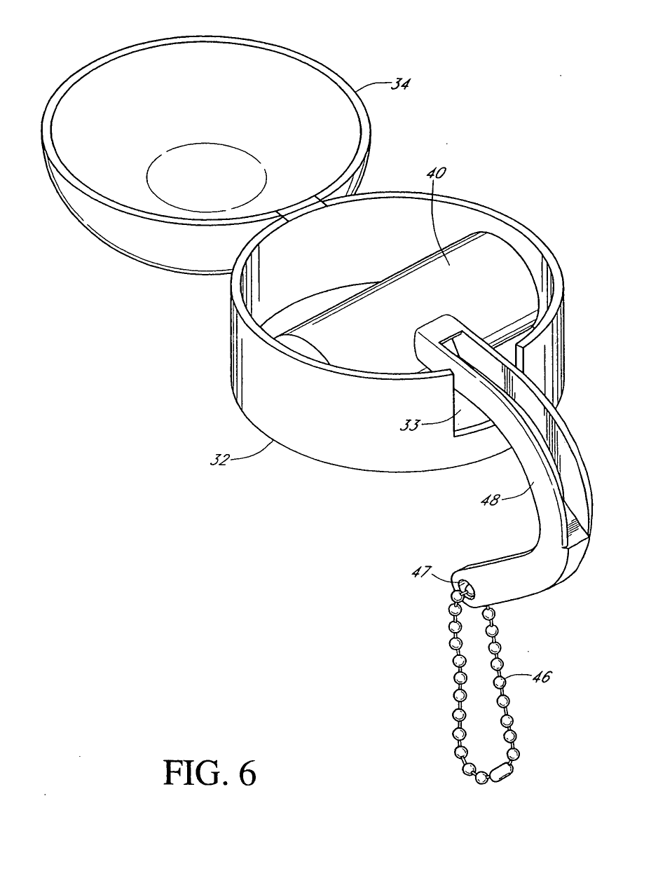

FIG. 6 illustrates another preferred embodiment of a hanger assembly. In this embodiment, the axial shaft is rotatably mounted in the support structure and the proximal end of the hanger rod is rigidly secured to and extends from the axial shaft. In this embodiment, the support structure 32 is in the form of a housing provided with a lid or cover 34 which may be closed. A rotatable cylinder or shaft 40 is supported at opposite ends in the housing for rotatable movement as previously described. The axial shaft may be one piece with unitary axles projecting at opposite ends, or it may be a hollow cylinder coaxially hinged on a separate axle extending through it. Hanger rod 48 is secured to and extends from axial shaft 40 along an axis substantially normal to the axis of rotation of the shaft. The proximal end of the hanger rod may be rigidly secured to the axial rotatable shaft by any suitable means. It may be molded or formed unitary with the axial shaft, or it may be secured by welding, adhesive, etc. The proximal end of the hanger rod may be solid or bifurcated using a shape or design like or similar to that shown in FIG. 2. Similarly, the axial rod may be bifurcated or split with each end rotatably mounted in the support structure or rotatably mounted on an axle secured in the support structure. The front of the support structure 32 is provided with an adequate opening 33 to allow the range of rotation for the hanger rod relative to horizontal as also previously described. Other support structure forms and shapes may also be used.

Although the previously described embodiments have shown a hinged hanger rod with a hook at the distal end, alternative hanger rod configurations may be used. For example, a single rigid hanger rod extending from the support structure may have a flexible tether secured at its distal end. Examples of a flexible tether include a ribbon, cord, or a beaded chain or strap with a clasp, buckle, snap or other unlocking or otherwise disengaging device for removably securing a purse strap. Such an embodiment is illustrated in FIG. 6 with beaded chain 46 secured on hanger rod 48 through hole 47. Likewise, the flexible tether may be secured on a hanger rod through hole 38 shown in FIG. 1B and FIG. 2 or other opening at or adjacent to the distal end of the hanger rod.

FIG. 7 illustrates the use of the hanger assembly on a horizontal table surface 30 or other generally flat horizontal surface such as a countertop, shelf, and the like, without resting on the tabletop edge 45 and thereby allowing the full weight of a handbag to be supported by the support structure 10.

In all of the embodiments described herein, the freedom of rotation of the axial shaft or of the proximal end of the hanger rod on the axial shaft allows the weight of the object to be suspended on the hanger rod to position itself and steady the hanger assembly on the horizontal surface without danger of being inadvertently or accidentally moved from its stationary position. However, the object will also be adequately supported if the hanger assembly is used on a shelf which does not allow unimpeded gravitational positioning of the object to be supported directly below the hanger assembly. For example, if a drawer or skirt or other generally vertical surface extends below the horizontal surface on which the assembly is to be placed, the hanger rod may simply rest against the vertical surface, thereby providing suitable support for the suspended hanging object. The hinge on the hanger rod provides proper positioning of the supported article without exerting force to pull the support member from the horizontal surface.

The hanger assembly described herein may also be used to hang a coat or jacket from a cabinet or shelf in an office or establishment, convenient if a door hanger or coat rack is not available. Similarly the hanger assembly may be quite useful for hanging tools, products, or accessories and for hanging parts or components or painted objects for drying in a workshop, garage, etc. The exterior of the support structure of the embodiments described herein may be decorated, jeweled or inlaid with stones, glass, etc. or painted with designs as desired. For example, the lid 34 may be provided with a time piece as may be the surface of one or more of the support members of the embodiments previously illustrated. Other features, components and structures may be used within the purview of the embodiments described and claimed herein.

What is claimed is:

1. A hanger assembly configured for being removably placed on a generally flat horizontal elevated surface and for hanging objects downwardly therefrom comprising:
a support structure configured to rest on a generally flat horizontal surface and comprising an axial shaft mounted in said support structure along a single first axis above and generally parallel with said flat surface;
an elongated hanger rod having a proximal end secured to or mounted on said axial shaft and extending therefrom perpendicular to said first axis and wherein said proximal end is pivotal on and extends from said axial shaft at acute angles of between about ±30° relative to said horizontal surface.

2. A hanger assembly of claim 1 wherein said axial shaft is stationary in said support structure.

3. A hanger assembly of claim 1 wherein said axial shaft is a unitary component of said support structure.

4. A hanger assembly of claim 2 wherein the proximal end of said hanger rod includes a collar coaxially mounted on said axial shaft and rotatable thereon along said first axis.

5. A hanger assembly of claim 4 wherein said collar includes an open slot therealong for removably securing said hanger rod on said axial shaft.

6. A hanger assembly of claim 1 comprising a pair of stationary coaxial shafts mounted in said support structure.

7. A hanger assembly of claim 6 wherein said proximal end of the hanger rod is bifurcated and comprises a pair of collars each rotatably mounted on one of said stationary axial shafts, respectively.

8. A hanger assembly of claim 1 wherein said axial shaft is rotatably mounted in said support structure for rotation along said first axis and wherein said proximal end of said hanger rod is secured on said axial shaft.

9. A hanger assembly of claim 8 wherein said rotatable axial shaft is bifurcated.

10. A hanger assembly of claim 8 wherein said proximal end of said hanger rod is rotatably mounted on said axial shaft and is rotatable along a second axis normal to said first axis.

11. An assembly of claim 9 wherein said first shaft has a first diameter, and said second shaft has a second diameter, smaller than said first diameter.

12. A hanger assembly of claim 9 wherein said proximal end of said hanger rod is removably secured to said axial shaft.

13. A hanger assembly of claim 1 wherein said shaft support structure comprises one or more substantially flat bottom surfaces configured to rest on a flat surface.

14. A hanger assembly of claim 13 including slip resistant composition on said one or more flat bottom surfaces.

15. A hanger assembly of claim 1 wherein said support structure is unitary.

16. A hanger assembly of claim 1 wherein said support structure comprises opposite post members.

17. A hanger assembly of claim 16 having one or more lateral support members rigidly secured to said post members and configured to form a substantially rigid unitary support structure.

18. A hanger assembly of claim 1 wherein said hanger rod is hinged along its length between a distal end and said proximal end.

19. A hanger assembly of claim 18 wherein said distal end comprises a hook.

20. A hanger assembly of claim 19 wherein said hinged connection comprises a hinge along a second axis substantially parallel with said first axis.

21. A hanger assembly of claim 20 wherein said hanger rod comprises a proximal section having a first arch along its length and a distal section having a second oppositely faced arch along its length and whereby said hanger rod may be folded at said hinge.

22. A hanger assembly of claim 21 wherein said first and second arches have different dimensions whereby a space is provided between said hanger rod sections in a folded condition, said space configured for securing said hanger assembly on a handbag strap.

23. A hanger assembly of claim 22 comprising means for securing said hanger rod sections in a folded condition.

24. A hanger assembly of claim 23 wherein said means for securing said hanger rod sections comprises holding clasping means formed or mounted on said support structure for receiving said distal hanger section.

25. A hanger assembly of claim 24 wherein said clasping means comprises a recess or notch.

26. A hanger assembly of claim 23 wherein said means for securing comprises magnets.

27. A hanger assembly of claim 23 wherein said means for securing comprises a releasable locking mechanism.

28. A hanger assembly of claim 22 wherein said support structure includes a recess configured to releasably snap-fit said distal section thereon in a folded condition.

29. A hanger assembly of claim 22 wherein said proximal section comprises a slot for receiving said distal section in a folded condition.

30. A hanger assembly of claim 1 having a flexible tether secured to a distal end of said hanger rod.
